(19) United States
(12) Patent Application Publication
(10) Pub. No.: US 2005/0039054 A1
(43) Pub. Date: Feb. 17, 2005

(54) Authentication system, server, and authentication method and program

(76) Inventors: Fumiko Satoh, Yokohama-shi (JP); Takayuki Itoh, Yokohama-shi (JP); Masayoshi Teraguchi, Yokohama-shi (JP); Yumi Yamaguchi, Yamato-shi (JP)

Correspondence Address: David Aker, 23 Southern Road, Hartsdale, NY, 10530, US

(21) Appl. No.: 10/917,712

(22) Filed: Aug. 14, 2004

(30) Foreign Application Priority Data
Aug. 14, 2003 (JP) 2003-293643

(51) Int. Cl. H04L 9/00

(52) U.S. Cl. 713/201

(57) ABSTRACT

An authentication system with a single sign on having less influence on the service performance to provide a service via a network. The authentication system comprises a provider 20 for providing a service, a security token service 40, and a proxy service 30 interposed between the security token service 40 and the provider 20. The proxy service 30 preserves an authentication result of the security token service 40, and vicariously executes the authentication for a client based on the authentication result preserved by itself without transferring an authentication request received from the provider 20 to the security token service 40 under certain conditions. Moreover, when it is clear that a service can be provided to the client based on the service use history of the client 10 preserved by itself, the provider 20 provides the service to the client 10 without making the authentication request.

### FIELD OF THE INVENTION

The present invention relates to a user authentication that is performed to provide a service via a network, and more particularly to a system and method for performing a user authentication with a single sign on.

### BACKGROUND ART

When employing a pay service from a plurality of providers that is provided on the Internet, it is often required to authenticate a client receiving the service to manage a payment amount and an account. Conventionally, since each provider mostly made the client authentication by a different method, the client authentication was made independently for respective services. However, to utilize the services more freely, it is preferred to implement a Single Sign On using the client authentication common among the plurality of providers.

As means for implementing the Single Sign On, it is considered that a Proxy Service for collectively managing the plurality of providers and a Security Token Service for making the client authentication are introduced. Herein, the Security Token Service indicates an agency for authenticating the client, which resides independently from any of the clients, the providers and the Proxy Service. There is a conventional technique of this kind in which the Proxy Service is disposed between client and provider, and instead of the client, the Proxy Service requests the client authentication, thereby implementing the Single Sign On for the plurality of providers (e.g., reference is made to Japanese Published Unexamined Patent Application No. 2002-288139 and Japanese Published Unexamined Patent Application No. 2002-32340 corresponding to United States patent Application publication 2002/0007460, hereinafter, Patent Documents 1 and 2).

Conventionally, a model for implementing the Single Sign On without introducing the Proxy Service has been offered in which the client authentication once made in a predetermined provider is ordered around the plurality of providers (e.g., reference is made to Japanese Published Unexamined Patent Application No. 2002-335239, hereinafter, Patent Document 3). In this conventional technique, when the client holds an authentication token issued by provider A, and wants to be connected to provider B by presenting the authentication token, provider B requests provider A of issuer to examine the authentication token.

### PROBLEMS IN THE PRIOR ART

As described above, the method for implementing the Single Sign On to make efficiently the client authentication on the network has been conventionally offered. However, in the conventional technique in which the Proxy Service that is disposed between client and provider requests the client authentication to be vicariously executed, the Proxy Service becomes a bottleneck, resulting in lower total performance of the system, when the client or provider is a portable terminal with low processing capability, or an electronic signature or encryption requiring a great load on the processing is applied, as disclosed in Patent Documents 1 and 2.

Also, in the conventional technique in which the client authentication result from a predetermined provider is diverted to some other providers, when the client is connected to another provider different from the previous provider (or the predetermined provider making the authentication), the authentication result is notified from the predetermined provider to another provider, resulting in increased number of communications required to provide the service, lowering the performance, as disclosed in Patent Document 3.

### SUMMARY OF THE INVENTION

Thus, in the light of the above-mentioned problems, it is an object of the invention to implement the single sign on having less influence on the performance to provide a service requiring the client authentication via a network.

In order to accomplish the above object, this invention is implemented as an authentication system for performing a client authentication with a single sign on by collectively managing a plurality of providers for providing predetermined services via a network, which is configured as follows. This authentication system comprises a provider for providing a predetermined service via the network, an authentication server (security token service) for performing the authentication for a client making a service request to the provider, and a proxy server (proxy service) for managing an authentication request which the provider makes to the authentication server, the proxy server being interposed between the authentication server and the provider. The proxy server preserves an authentication result of the authentication server, and vicariously executes the authentication for the client based on the preserved authentication result without transferring the authentication request received from the provider to the authentication server under certain conditions.

More preferably, the provider preserves a service use history of the client, and when it is clear that a service can be provided to the client based on the service use history, the service is provided to the client without making the authentication request. Also, the proxy server acquires and manages the service use history of the client from the provider, and determines whether or not the service can be provided to the client, based on the authentication result from the authentication server and the service use history, in response to an authentication request from a predetermined provider. Moreover, the proxy server accumulates the service use history of each client for comparison by circulating around the plurality of providers, selects the latest contents and updates the service use history of each client in each provider with the latest contents.

Also, another authentication system of the invention comprises a plurality of providers for providing predetermined services via a network, and a verification server (proxy service) for determining whether or not the service can be provided to a client making a service request to a predetermined provider in response to a verification request from the predetermined provider. The provider preserves a service use history of the client, and the verification server generates encoded data including the authentication information of the client and the information of the service use number by the client to provide the encoded data to the client, and acquires and manages the service use history from the provider, in which when a predetermined client makes a service request to a predetermined provider, employing the encoded data, the verification server determines whether or not the service can be provided by collating the encoded data and the service use history of the client in response to a verification request from the provider.

Herein, when a predetermined client makes a service request employing the encoded data, the provider provides a service to the client without making a verification request to the verification server, if it is clear that the service can be provided to the client by collating the encoded data and the service use history. Also, the verification server accumulates the service use history of each client for comparison by circulating around the plurality of providers, selects the latest contents and updates the service use history of each client in each provider with the latest contents.

Moreover, in order to accomplish the above object, another aspect of the invention is implemented as a server (proxy server) for implementing a single sign on by collectively managing a plurality of providers for providing predetermined services via a network, which is configured as follows. That is, this server comprises use history storing means for storing a service use history of a predetermined client in the providers, authentication result storing means for storing an authentication result for the predetermined client that is acquired by requesting a predetermined authentication server, and verification means for determining whether or not the service can be provided to the predetermined client employing the service use history and the authentication result, in response to an inquiry from the providers. The verification means requests the authentication server to make a client authentication for determining whether or not the service can be provided, when the authentication result preserved in the authentication result storing means is invalid.

Herein, this server may further comprise use history accumulating or distributing means for accumulating the service use history of each client by circulating around the plurality of providers under management, and distributing the latest service use history to each provider. This use history accumulating or distributing means preferentially circulates around the providers making no connection for inquiring whether or not the service can be provided for a long time, the providers having a greater number of communications with the clients for which the latest service use history is accumulated by the use history accumulating means, or the providers having a greater total amount of communication with the clients.

Also, this server may further comprise encoded data generating means for generating encoded data including the authentication information of the client and the information of the service use number by the client, in which when a predetermined client makes a service request to a predetermined provider, employing the encoded data, the verification means determines whether or not the service can be provided by collating the encoded data and the service use history of the client stored in the use history storing means.

Furthermore, this invention is implemented as the following authentication method for making the authentication for a client making a service request to a provider, employing a computer. That is, this authentication method comprises a first step of collating encoded data in which a service use history of the client is encoded and the information of the service use history of the client stored in predetermined storing means, a second step of determining whether or not the service can be provided to the client, based on the authentication information for the client stored in the predetermined storing means, when a collation result at the first step is “false”, and a third step of requesting a predetermined authentication server to authenticate the client and determining whether or not the service can be provided to the client based the acquired authentication result, when the authentication information for use at the second step is invalid.

And this authentication method may further comprise a step of determining that the service can be provided to the client when the collation result at the first step is “true”, and a step of storing the authentication result acquired at the third step as the authentication result for use at the second step in predetermined storing means.

Also, the invention is implemented as a program for controlling a computer to function as the server (proxy service), or enabling a computer to perform a processing corresponding to each step in the above authentication method. This program may be stored and delivered in a magnetic disk, an optical disk, a semiconductor memory, or other recording media, or distributed and provided via the network.

### ADVANTAGES OF THE INVENTION

In this invention as constituted in the above way, the proxy service for collectively managing the providers may be located at a higher level than the providers, whereby the proxy service does not become a bottleneck in making the authentication.

Also, the client authentication with the security token service or the proxy service may be omitted under certain conditions, whereby the communication between proxy service and security token service, or communication between provider and proxy service is omitted, giving rise to an effect of avoiding lower performance when the provider provides the service.

Also, in this invention, the proxy service accumulates the information necessary for the client authentication and distributes the latest information to each provider by circulating around the providers under management, whereby there are more chances in which the client authentication with the security token service or the proxy service can be omitted, giving rise to an effect of achieving a higher performance of the entire system.

### BRIEF DESCRIPTION OF THE DRAWINGS

These and other aspects, features, and advantages of the present invention will become apparent upon further consideration of the following detailed description of the invention when read in conjunction with the drawing figures, in which:

FIG. 1 is a block diagram showing the overall configuration of a system for implementing the single sign on according to an embodiment of the present invention;

FIG. 2 is a block diagram showing an example of the hardware configuration of a computer apparatus suitable for implementing each component to constitute the system of the single sign on according to this embodiment;

FIG. 3 is a diagram showing the functional configuration of a provider, a proxy service and a security token service that are an authentication system for the client according to this embodiment;

FIG. 4 is a diagram showing a procedure for client authentication in the single sign on according to this embodiment;

FIG. 5 is a flowchart for explaining the procedure for client authentication according to this embodiment;

FIG. 6 is a flowchart for explaining a collation process of service use history of the client performed by the provider according to this embodiment;

FIG. 7 is a flowchart for explaining a procedure for client verification with the proxy service according to this embodiment;

FIG. 8 is a flowchart for explaining an operation of the proxy service to accumulate and distribute the service use history of each client by circulating around the providers according to this embodiment;

FIG. 9 illustrates the operation of client, provider and proxy service when the client purchases a PayWord coupon ticket according to this embodiment;

FIG. 10 illustrates the operation of client, provider and proxy service at a first request to the provider according to this embodiment;

FIG. 11 illustrates the operation of client, provider and proxy service at a continuous request to the same provider according to this embodiment; and

FIG. 12 illustrates the operation of client, provider and proxy service in making a request again to the previous provider after requesting the other provider according to this embodiment.

### DETAILED DESCRIPTION OF THE INVENTION

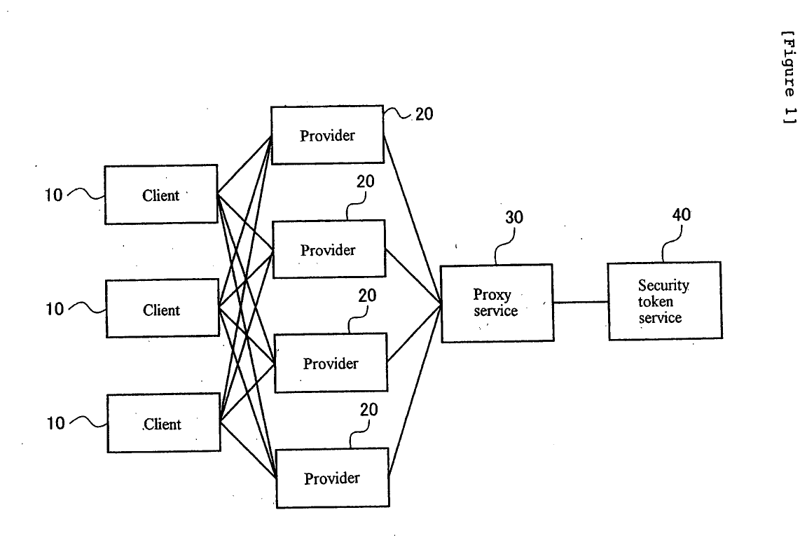

Referring to FIG. 1, the system of this embodiment of the invention comprises the components of a client 10, a provider 20, a proxy service 30, and a security token service 40. These components are defined as follows.

The client 10 is a component for making a request to the provider 20 for a service.

The provider 20 is a component for providing the service to the client 10 and caching a use history of the client 10.

The proxy service 30 is a component for caching an authentication result of the client 10 and managing the use history of the client 10 in each provider 20.

The security token service 40 is a component for authenticating the client 10.

The proxy service 30 that collectively manages the information of all the providers 20 and all the clients 10, and the security token service 40 that serves as a client authentication agency are introduced into the system of this embodiment. A client authentication request is issued to the security token service 40 by any one of the clients 10, the providers 20 and the proxy service 30, but it is less preferable that the client authentication result of the security token service 40 is held by the client 10 itself. Accordingly, the client authentication request is issued to the security token service 40 by the proxy service 30 in the following description.

As shown in FIG. 1, in this embodiment, the proxy service 30 that is placed at the upper level of the plurality of providers 20 collectively manages the information of each provider 20 and the client information such as the result of client authentication, and provides the client information to each provider 20. Moreover, the proxy service 30 determines whether or not the service can be provided (hereinafter referred to as client verification), employing the result of client authentication by the security token service 40, and transmits the determination result to the provider 20.

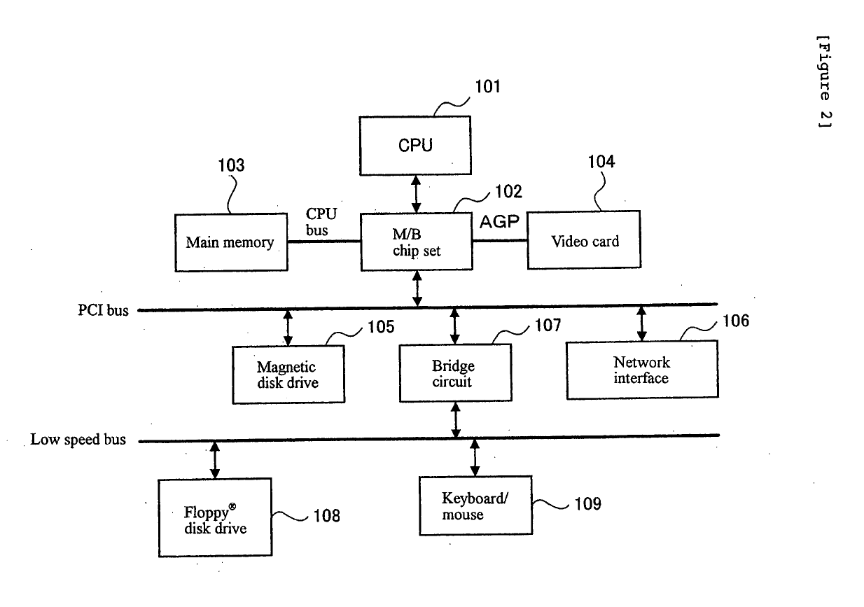

The computer apparatus as shown in FIG. 2 comprises a CPU (Central Processing Unit) 101 as operation means, a main memory 103 connected via an M/B (Mother/Board) chip set 102 and a CPU bus to the CPU 101, a video card 104 connected via the M/B chip set 102 and an AGP (Accelerated Graphics Port) to the CPU 101, a magnetic disk drive (HDD) 105 connected via a PCI (Peripheral Component Interconnect) bus to the M/B chip set 102, a network interface 106, and a floppy disk drive 108 and a keyboard/mouse 109 connected via the PCI bus, a bridge circuit 107 and a low speed bus such as an ISA (Industry Standard Architecture) bus to the M/B chip set 102.

FIG. 2 illustrates the hardware configuration of the computer apparatus for implementing this embodiment, but various other variations may be made as far as this embodiment is applicable. For example, instead of providing the video card 104, a video memory may be included to process image data in the CPU 101, or an external storage unit such as a CD-R (Compact Disc Recordable) or DVD-RAM (Digital Versatile Disc Random Access Memory) may be provided via an interface such as an ATA (AT Attachment) or SCSI (Small Computer System Interface). Also, the client 10 may be the computer apparatus as shown in FIG. 2, or the information equipment such as a PDA (Personal Digital Assistant) or portable telephone having a network function, as described above.

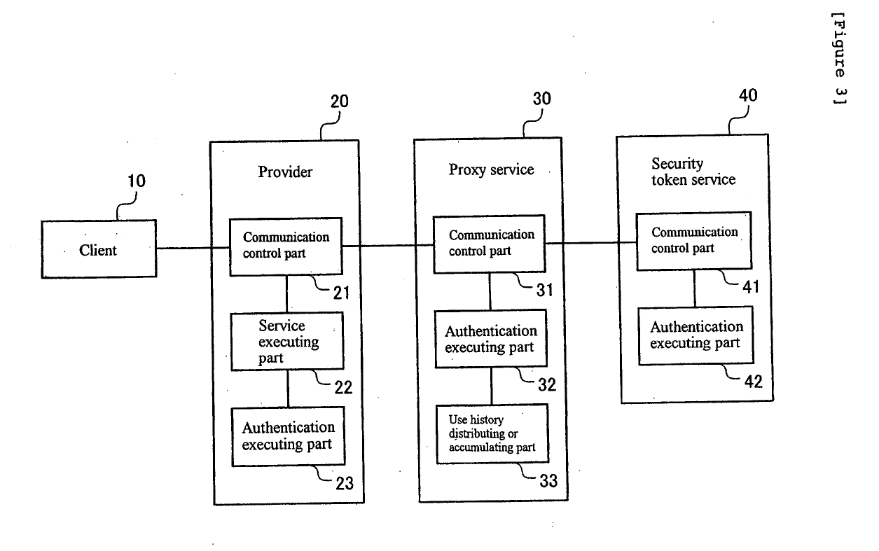

As illustrated in FIG. 3, in this embodiment, the provider 20 comprises a communication control part 21 for making data communication with the client 10 and the proxy service 30, a service executing part 22 for providing a predetermined service to the client 10, and an authentication executing part 23 for making the client authentication. The details of the client authentication by the authentication executing part 23 of the provider 20 will be described below.

In the above configuration, the communication control part 21 is implemented by the CPU 101 under program control in the computer apparatus as shown in FIG. 2 and a network interface 106, for example. The service executing part 22 and the authentication executing part 23 are implemented by the CPU 101 under program control in the computer apparatus as shown in FIG. 2, for example. A program for implementing the functions of the communication control part 21, the service executing part 22 and the authentication executing part 23 in the CPU 101 may be stored in and delivered from a magnetic disk, an optical disk, a semiconductor memory, or other recording media, or distributed via the network.

The proxy service 30 comprises a communication control part 31 for making data communication between the provider 20 and the security token service 40, an authentication executing part 32 for making the client authentication without regard to the security token service 40, and a use history distributing or accumulating part 33 for distributing or accumulating a service use history of client 10 used for the client authentication by the authentication executing part 32. Because of this use history distributing or accumulating part 33, the proxy service 30 can accumulate the service use history of each client 10 for comparison by accumulating it when reading or polling or “circulating around” the providers 20 under management and always preserve the latest use history of individual client 10. Also, the latest use history is distributed to each provider 20 in circulating around the providers 20. Thus, the invention may operate in two distinct ways. The latest use history may be sent from one provider 20 to all the other providers 20. If all providers 20 have the latest information, then the proxy service 30 only has to obtain the use history from one provider 20. However, if for some reason all of the providers 20 may not have the latest use history, the proxy service 30 can contact all of the providers to be sure that a complete use history has been obtained.

The details of the client authentication by the authentication executing part 32 in the proxy service 30 are described below.

In the above configuration, the communication control part 31 is implemented by the CPU 101 under program control in the computer apparatus as shown in FIG. 2 and the network interface 106, for example. The authentication executing part 32 and the use history distributing or accumulating part 33 are implemented by the CPU 101 under program control in the computer apparatus as shown in FIG. 2, for example. A program for implementing the functions of the communication control part 31, the authentication executing part 32 and the use history distributing or accumulating part 33 in the CPU 101 may be stored and delivered in a magnetic disk, an optical disk, a semiconductor memory, or other recording media, or distributed via the network.

The security token service 40 comprises a communication control part 41 for making data communication with the proxy service 30, and an authentication executing part 42 for making the client authentication. The client authentication by the authentication executing part 42 in the security token service 40 may be made by various well-known authentication methods using a password or the client ID information.

In the above configuration, the communication control part 41 is implemented by the CPU 101 under program control in the computer apparatus as shown in FIG. 2 and the network interface 106, for example. The authentication executing part 42 is implemented by the CPU 101 under program control in the computer apparatus as shown in FIG. 2, for example. A program for implementing the functions of the communication control part 41 and the authentication executing part 42 in the CPU 101 may be stored in and delivered from a magnetic disk, an optical disk, a semiconductor memory, or other recording media, or distributed via the network.

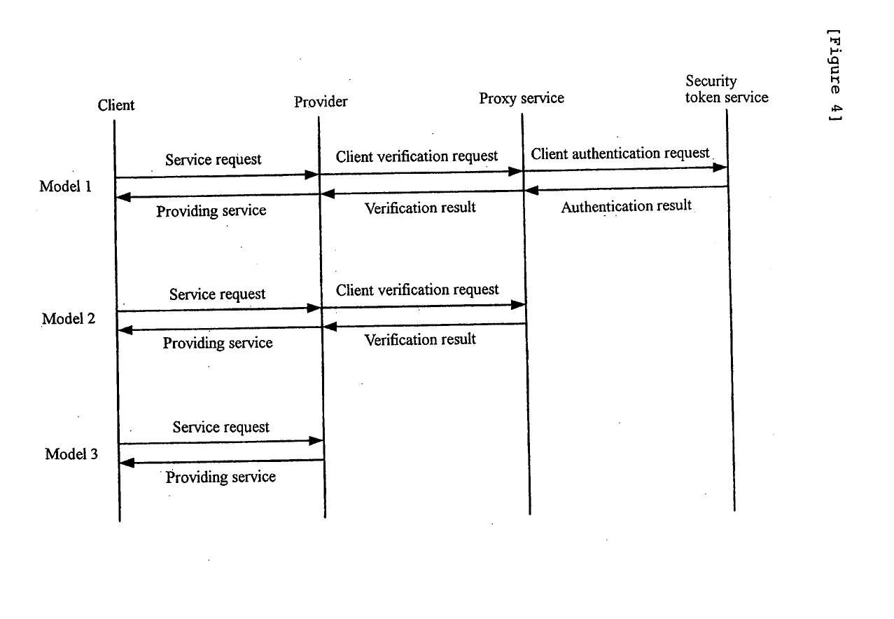

FIG. 4 is a diagram showing a procedure for client authentication in the single sign on according to this embodiment.

In model 1 as shown in FIG. 4, if the client 10 makes a service request to the predetermined server 20, the provider 20 requests the proxy service 30 to make the client verification to determine whether or not the service can be provided to the client 10 making the service request.

The proxy service 30 request the security token service 40 to authenticate the client 10, in response to this request, and acquires the authentication result. The proxy service 30 determines whether or not the service can be provided to the client 10, based on the acquired authentication result, and notifies the determination result (client verification result) to the provider 20.

The provider 20 provides the service to the client 10, if the service can be provided in accordance with the client verification result received from the proxy service 30.

The above procedure for client authentication with model 1 is the most fundamental of the client authentication in this embodiment. With model 1, a client authentication method is decided by the security token service 40, and the client authentication results are collectively managed by the proxy service 30, thereby easily implementing the single sign on for the services of the plurality of providers 20.

However, in model 1, every time the client 10 makes a connection to a certain provider 20, a procedure is followed in which the provider 20 requests the proxy service 30 to make the client verification, and further the proxy service 30 requests the security token service 40 to make the client authentication. In this case, for a service request of the client 10, two communications are required between provider 20 and proxy service 30, between proxy service 30 and security token service 40, other than the communication between client 10 and provider 20. Accordingly, it takes a longer communication time to make two communications, as compared with the client authentication that is not the single sign on but made only through the communication between client 10 and provider 20.

Thus, the communication required for providing service may be omitted by simplifying the client authentication in accordance with the service use history at the client 10.

Model 2 as shown in FIG. 4 represents a procedure for client authentication that is simplified by omitting the communication between proxy service 30 and security token service 40. Model 3 represents a procedure for client authentication that is simplified by omitting the communication between proxy service 30 and security token service 40 and the communication between proxy service 30 and provider 20.

In order to perform the simple client authentication with the models 2 and 3, the provider 20 and the proxy service 30 of this embodiment have the following configuration.

The authentication executing part 23 of the provider 20 holds the use history of the service for each client 10 using the service. This use history is stored in the main memory 103 or the magnetic disk unit 105 of the computer apparatus as shown in FIG. 2, for example.

Also, the authentication executing part 32 of the proxy service 30 caches the client authentication result acquired by requesting the security token service 40. The client authentication result has a definite term of validity. This client authentication result is stored in the main memory 103 or the magnetic disk unit 105 of the computer apparatus as shown in FIG. 2, for example.

Also, the proxy service 30 holds the ID (identification) information of the provider 20 requesting the client authentication. This ID information is stored in the main memory 103 or the magnetic disk unit 105 of the computer apparatus as shown in FIG. 2, for example.

The client authentication is performed in model 1
when a first service request from the client 10 to the provider 20 takes place, and
when the term of validity of client authentication result cached in the proxy service 30 has passed.

Also, the client authentication is performed in model 2
when the client authentication result held in the proxy service 30 is cached valid.

Also, the client authentication is performed in model 3
when the client verification is made using the service use history of the client 10 held in the provider 20.

Selecting which model is employed for the client authentication is dynamically made when a service request is made from the client 10 to predetermined provider 20.

An overall procedure for client authentication according to this embodiment will be described below.

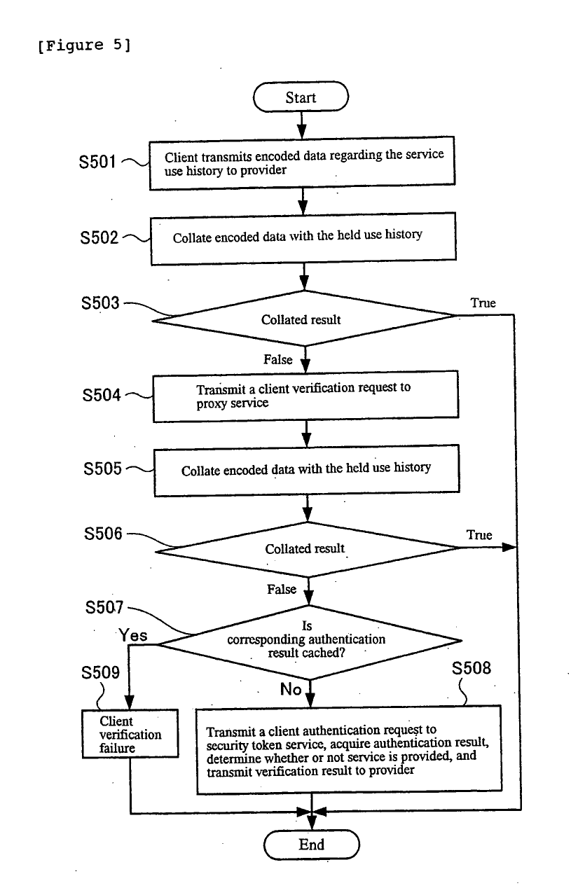

Referring to FIG. 5, it is assumed that the client 10 holds data encoded from the use history of service (hereinafter referred to as encoded data) to employ the past service (service provided by each provider 20 that is generalized by the single sign on). This encoded data is created in the proxy server 30, for example, and provided to the client 10. The details of the encoded data will be described below.

As shown in FIG. 5, the client 10 transmits the encoded data regarding the use history of service to the provider 20 in making a new service request or in response to a request from the provider 20 (step 501).

The provider 20 collates the encoded data for the use history received from the client 10 with the use history held by the provider 20 (step 502). The details of the collation process will be described below. If the collation result is “true”, it is determined that the service can be provided, and it is regarded that verification of the use history of the client 10 is completed. The request to the proxy server 30 for client verification is omitted (step 503). At this time, the client authentication with model 3 is applied.

If the collation result at step 503 is “false”, the provider 20 transmits the use history of client 10 and the encoded data to the proxy server 30 to request the client verification (step 504). The reason why the collation result at step 503 is “false” is any one of the followings.
The client 10 has made a service request to another provider 20 immediately before, so that the use history held by the provider 20 during communication at present is older (reason 1).
The first service request for the client takes place, whereby the corresponding use history is not held (reason 2).
The client 10 forges the information of the use history (reason 3).

The proxy service 30 receives a client verification request from the provider 20, and then collates the encoded data included in the client verification request and the use history held in the proxy service 30 (step 505). Since the use history managed in the proxy service 30 has the latest contents accumulated from each provider 20, when the reason why the collation result is “false” in step 503 is reason 1, the collation result here is “true”.The details of this collation process will be described below. If the collation result at step 506 is “true”, it is determined that the service can be provided, whereby verification of the use history of the client 10 is completed. The request to the security token service 40 for the client authentication is omitted (step 506). At this time, the client authentication with model 2 is applied. If the collation result at step 506 is “false”, the proxy service 30 checks whether or not the client authentication result for the client 10 is cached for itself (i.e., the client 10 is requested for verification for the first time) (step 507). If the corresponding client authentication result is not cached, a request for client authentication is made to the security token service 40 to acquire the authentication result, because the reason why the collation result at step 503 is “false” is reason 2. The proxy service 30 determines whether or not the service can be provided to the client 10, based on the client authentication result by the security token service 40, and transmits the client verification result to the provider 20 (step 508). At this time, the client authentication with model 1 is applied.

If the corresponding authentication result at step 507 is cached, the proxy service 30 returns the verification result of client verification failure to the provider 20, because the reason why the collation result at step 503 is “false” is recognized as reason 3 (step 509). In this case, the authentication request to the security token service 40 is omitted, whereby the procedure for client authentication corresponds to model 2.

As shown in FIG. 6, if the provider 20 receives a service request from the client 10 with a service use history, then the authentication executing part 23 retrieves whether or not the corresponding service use history is held (step 601). If the corresponding service use history is held, the authentication executing part 23 collates the service use history with the service use history received from the client 10 (steps 602, 603). If the collation result is “true”, it is determined that the service can be provided, such as the client verification, whereby the service executing part 22 provides a service to the client 10 (step 604).

If the corresponding service use history at step 602 is not detected, and if the collation result at step 603 is “false”, a request for client verification is transmitted to the proxy service 30 (step 605). The client verification result is acquired from the proxy service 30 (step 606). If it is determined that the service can be provided to the client 10, based on the client verification result, the service executing part 22 provides a service to the client 10 (step 607, 604). On the other hand, if it is determined that the service can not be provided to the client 10, an error processing (transmitting a message for refusing the service to the client 10) is performed, and the processing is ended (step 608).

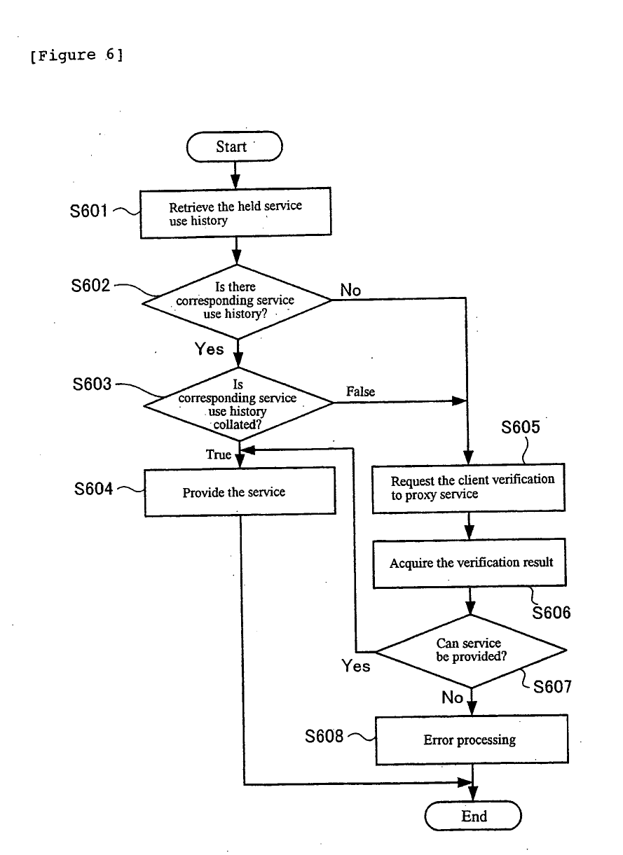

As shown in FIG. 7, if the proxy service 30 receives a client verification request from the provider 20, the authentication executing part 32 retrieves whether or not the client authentication for the client 10 that is a subject of the client verification request is cached (step 701). If the corresponding cache data exists, the authentication executing part 32 checks whether or not the cache data is valid (the term of validity has passed) (steps 702, 703). If the cache data is valid, the authentication executing part 32 verifies the service use history of the client 10, based on the client authentication result of the cache data (step 704).

If the corresponding cache data does not exist at step 702, or if it is determined that the cache data is not valid at step 703, a request for client authentication is transmitted to the security token service 40 (step 705). The client authentication result is acquired from the security token service 40 (step 706). If it is determined that the client 10 is valid, based on the authentication result, the authentication result is cached by the authentication executing part 32 (steps 707, 708). The authentication executing part 32 verifies the service use history of the client 10, based on the newly cached authentication result (step 704).

If the use history is valid as a result of verifying the service use history of the client 10, the client verification result indicating that the service can be provided to the client 10 and the verified service use history are transmitted to the provider 20 (steps 709, 710).

If it is determined at step 709 that the service use history is not valid, and if the authentication result indicating that the user is not valid is obtained at step 707, the client verification result indicating that the service can not be provided to the client 10 is transmitted to the provider 20 (step 711).

The client authentication is executed by dynamically selecting any one of the models 1, 2 and 3 in accordance with a situation when the client 10 makes a service request, whereby the performance of provider 20 to provide the service is enhanced. However, to exhibit the effect of enhancing the performance to the utmost, it is desirable to apply model 3 as much as possible. The information exchange is made between the providers 20 so that the use history of client 10 preserved in the provider 20 to which the client 10 is connected may be the latest at any time, increasing the chances of applying model 3.

Thus, it is considered that the latest use history of client 10 is distributed to a plurality of providers 20 efficiently. In this embodiment, the proxy service 30 circulates through the providers 20 and accumulates (Takes) the latest use history of client 10 preserved in the provider 20, and at the same time, when the old use history is preserved in the provider 20, the latest use history is distributed to update (Gives) the use history, whereby the latest use history can be distributed to move provider 20.

In this embodiment, the proxy service 30 employs the score of provider 20 calculated in accordance with the following criteria to accumulate the use history of client 10 from the provider 20, or distribute the latest use history to the provider 20 as effectively as possible.

Criterion 1: The provider 20 making no connection to the proxy service 30 for a long time has a possibly older use history of client 10, in which the older use history must be updated with the latest use history by having the latest use history distributed from the proxy service 30 as early as possible. Hence, such provider 20 is given a higher score.

Criterion 2: When the proxy service 30 accumulates the latest use history of client 10 from the provider 20, it is considered to which provider 20 this latest use history is distributed more effectively. The most effective selection is to distribute the latest use history to the provider 20 having a greater number of communications with the client 10 from which the latest use history is accumulated. Hence, such provider 20 is given a higher score.

Criterion 3: Noting the accumulation of the use history, a simple criterion for selecting the provider 20 having a greater amount of latest use history is that the provider 20 having a greater total amount of communications with the client 10 has a greater amount of latest use history. Hence, such provider 20 is given a higher score.

The following numerical expression 1 is one example of score calculation expression to evaluate the above criteria 1, 2 and 3 for a predetermined provider i.

$${S}_{i1} = Δ {t}_{i}$$

$${S}_{i2} = {\sum }_{j} {n}_{ij}$$

$${S}_{i3} = {m}_{i}$$

Where Δtᵢ is the time elapsed since the last communication with the proxy service 20 in the provider i, n_{i,j} is the number of communications between provider i and client j (only the client 10 for which the proxy service 30 possesses the latest use history), and mᵢ is the total number of communications with the clients 10 in the provider i.

The weighted sum of these three values
Sᵢ=aSᵢ₁+bSᵢ₂+cSᵢ₃ (a, b, c are appropriate coefficients) is the score of provider 1.

The proxy service 30 calculates the score for each provider 20, and selects the provider 20 in the order of higher score by circulating around the providers 20. For the providers 20 through which the proxy service 30 circulates, the use history possessed by each provider 20 is accumulated, and the latest use history possessed by the proxy service 30 is distributed to each provider 20. Thereby, there is a higher probability that the latest use history of client 10 is held in the provider 20 to which the client 10 makes a service request, increasing the chances that model 3 is applicable. The average value of the number of connections necessary to provide the service is decreased, and the performance of the entire system at the time of providing the service is enhanced.

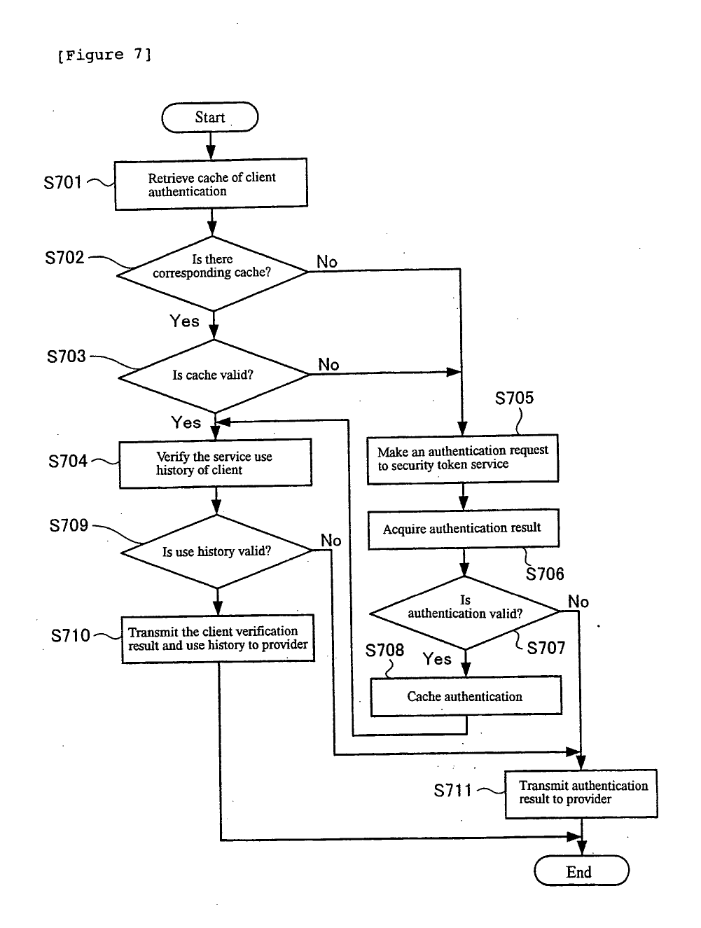

Referring to FIG. 8, the use history distributing or accumulating part 33 of the proxy service 30 computes the score of each provider 20 under management at a predetermined timing (e.g., periodically) and decides the providers 20 around which the proxy service 30 circulates (step 801). And the proxy service makes connection to the provider 20 of circulation destination (i.e., having the largest score) (step 802), and compares the use history regarding one client 10 among the use histories of service possessed by the provider 20 with the use history of the client 10 possessed by the proxy service 30 (step 803).

As a result of comparison, when the provider 20 has a newer use history than the proxy service 30, the use history distributing or accumulating part 33 updates the use history of the proxy service 30 with that of the provider 20 (steps 804, 805). On the other hand, when the proxy service 30 has a newer use history than the provider 20, the use history distributing or accumulating part 33 updates the use history of the provider 20 with that of the proxy service 30 (steps 804, 806).

Then, a determination is made as to whether or not the use history distributing or accumulating part 33 has performed the steps 803 to 806 for the use histories for all the clients 10 serviced by the provider 20, and if there is any unprocessed use history left, the steps 803 to 806 are repeated for the use history by noting or successively polling each client 10. If the use histories for all the clients 10 are updated by noting successively the use history of each client, a circulating process for the provider 20 is ended (step 807).

As an example in this embodiment, an authentication system using PayWord as encoded data including the information of the use history of service in the client 10 will be described below.

PayWord can be employed as a coupon ticket used by the client 10 in making a service request. Also, the client 10 having made the service request is designated by verifying the use history for PayWord, allowing for the client verification Using PayWord, the client verification and the management for the use history are made, whereby the proxy service 30 also serves as a role of the accounting management on the client 10. However, the use history (last use history) for PayWord lastly used is required to make the client verification.

Herein, the details of PayWord used as an example of a one-way encoded coupon ticket will be described below.

PayWord involves a method for enabling the authentication between provider 20 and client 10 using a hash value calculated based on a one-way hash function and arbitrary random number To make the authentication with PayWord, the existence of CA (Certificate Authority) for issuing a certificate of the client 10 is presumed. First of all, priori preparations for the CA using PayWord, the client 10 and the provider 20 and then the use of PayWord will be explained. Also, it is supposed that the client 10 and the provider 20 know the same one-way hash function in advance.

Priori Preparations

1. CA issues a certificate Cu with signature of CA for the client 10.
2. The client 10 firstly determines a value Wₙ of the one-way hash function multiplied by availability n and arbitrary random number. The hash function h is multiplied by Wₙ n times, whereby n hash values W₀ to Wₙ₋₁ are obtained. That is,
   Wᵢ₋₁=h(Wᵢ) for i=1, . . . , n
3. The client 10 signs the certificate Cu and the value W₀ for use as the route value of PayWord, and transmits them to the provider 20.
4. The provider 20 authenticates the client 10 based on the transmitted certificate Cu and holds the value W₀.
   First Use (1st-Payment)
1. The client 10 transmits the frequency j for use and corresponding Wⱼ to the provider 20. Herein, a pair of j and Wⱼ to be transmitted is defined as PayWord.
2. The provider 20 multiplies the hash function by transmitted Wⱼ j times, and compares the obtained value of the hash function with the route value W₀ of PayWord held.
3. If those values are matched, the client is identical to the previously authenticated client 10, whereby the service is provided by the provider 20.
4. The provider 20 holds Wⱼ for the service request at the next time.
   Second Use (2nd-Payment)
1. The client 10 transmits the frequency k for use and corresponding Wⱼ₊ₖ to the provider 20.
2. The provider 20 multiplies the hash function by transmitted Wⱼ₊ₖ k times, and compares the obtained value of the hash function with the held value Wⱼ.
3. If those values are matched, the service is provided and the value Wⱼ₊ₖ is held.

The use of PayWord is allowed n times by repeating the same operation. The features of PayWord are as follows.
a. The client authentication and the management for the use history of the client 10 are both enabled only by calculating the hash value.
b. The value calculated by the one-way hash function is employed, whereby the illegal use is prevented.
c. An electronic signature of the client 10 is only required when the client 10 transmits the certificate Cu to the provider 20 in the priori preparation, and there is no need for signature of the client 10 when making the service request.
d. The calculation of the hash value is performed at a processing speed that is as fast as about 10,000 times the electronic signature, as pointed out.

In the system with the single sign on using such PayWord in this embodiment, the use history for PayWord is employed as the service use history of the client 10. The proxy service 30 serves to cache the client authentication result and the use history of the client 10 and issue PayWord. The service use history of the client 10 is managed using PayWord, whereby the client verification is easily made between client 10 and provider 20 to share the same PayWord coupon ticket among the plurality of providers 20.

A procedure for executing the single sign on will be described below. Herein, it is supposed that the hash function for use with PayWord is shared in advance among the clients 10, the providers 20 and the proxy service 30.

Purchasing Coupon Ticket

To begin with, the client 10 purchases a coupon ticket that is used in making the service request.

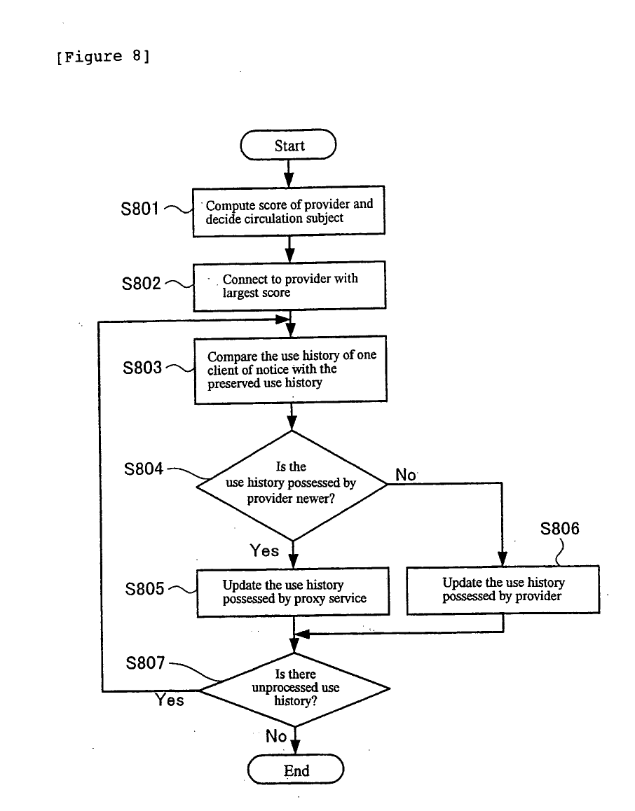

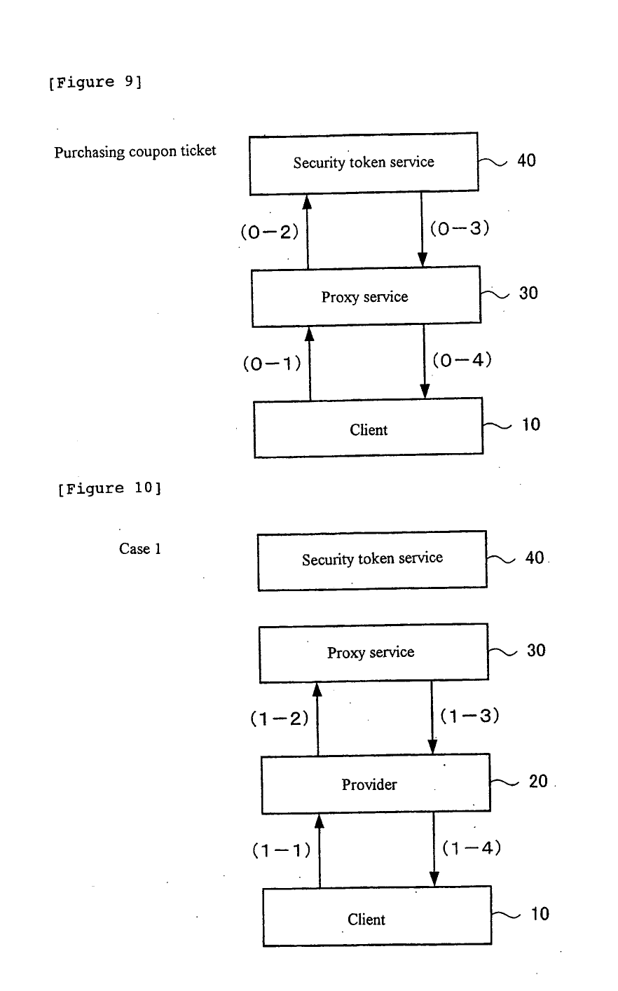

FIG. 9 illustrates the operation of the client 10, the provider 20 and the proxy service 30 when the client 10 purchases the PayWord coupon ticket.

As shown in FIG. 9, first of all, the client 10 transmits a purchase request for “purchasing a ticket of 10 coupons” and a security token (client ID and password) with electronic signature to the proxy service 30 (operation (0-1) in FIG. 9). In this case, a message is preferably encrypted for safer transmission.

The proxy service 30 presents the security token of the client 10 to the security token service 40 in response to the purchase request from the client 10 and makes a client authentication request and a coupon ticket purchase request (operation (0-2) in FIG. 9).

The security token service 40 verifies the security token of the client 10 transmitted from the proxy service 30, and issues a client authentication including an attribute of “purchasing a ticket of 10 coupons” to the proxy service 30 (operation (0-3) in FIG. 9).

The proxy service 30 creates PayWords for 10 coupons by referring to the attribute content received from the security token service 40, and returns 10 PayWord values and the route values W₀ to the client 10 (operation (0-4) in FIG. 9). Herein, the client authentication result received by the proxy service 30 is associated with the created 10 PayWord values and the route values W₀, as well as the client ID, and cached for the term of validity for the coupon ticket.

The client 10 can receive the service by employing the PayWord received from the proxy service 30 in the above way. Herein, the proxy service 30 alone knows the correspondence between the practical client ID and the route value W₀ used for the client authentication in making the service request, and holds the use histories of the client to all the providers 20, whereby the proxy service 30 can make the accounting management, by issuing a payment request at regular intervals.

An execution procedure for providing the service from the provider 20 to the client 10 will be described below. First of all, the basic conditions under which the execution procedure is decided are enumerated.
1. The client verification between client 10 and provider 20 is performed by verifying PayWord transmitted from the client 10 using the use history for PayWord held in the provider 20.
2. When the client verification with PayWord is successful, the connection between provider 20 and proxy service 30 may be omitted.
3. Only when the client verification with PayWord fails, the provider 20 makes connection to the proxy service 30 to request the verification. Failure of the client verification may be caused by any of the following factors.
   Factor 1: First service request for the client 10.
   Factor 2: The client 10 makes a service request to another provider 20 immediately before.
   Factor 3: The client 10 forges the information.
   Factor 4: The client 10 has not yet purchased the coupon ticket.
4. If the verification of the proxy service 30 points out that the factor 1 or factor 2 is the cause of failure, the service is provided by the provider 20.

Under the above conditions, the service providing procedure will be described in three cases as follows.
Case 1: Making the service request to predetermined provider 20A for the first time.
Case 2: Making consecutively the service requests to the provider 20A.
Case 3: Making the service request to the provider 20A again after receiving the service from the other provider 20B.

In this explanation of operation, when it is required to distinguish individual providers 20, the client 20 is suffixed with capital letters, such as provider 20A, 20B.

Case 1: First Request to Provider 20A.

FIG. 10 is a view showing the operation of the client 10, the provider 20A and the proxy service 30 in case 1.

The client 10 issues a service request to the provider 20A, based on PayWord received from the proxy service 30 (operation (1-1) in FIG. 10). At the same time, the client 10 transmits the client ID and PayWord Wᵢ corresponding to the necessary number of coupons to the provider 20A. Herein, when PayWord is employed for the one-way encoded coupon ticket, the provider 20A may employ the route W₀ of PayWord, instead of the client ID to identify the client 10. In this case, W₀ is employed as the temporary client ID that is only effective for the term of validity for the coupon ticket. Also, the provider 20A does not need to know the inherent client ID and it may be difficult to determine the client 10 from W₀; the route W₀ of PayWord is safer than where the client ID is directly employed to identify the client 10. Moreover, the message has greater safety by applying W₀ with signature and encryption for the client 10.

At this time, due to the first service request to the provider 20A, the provider 20A does not hold the use history of the client 10. Thus, the provider 20A presents the information of client 10 to the proxy service 30, and requests the proxy service 30 to make the client authentication and validity verification of PayWord Wᵢ (operation (1-2) in FIG. 10).

The proxy service 30, which caches the client authentication result acquired when the client 10 purchases the coupon ticket, confirms the validity of PayWord Wᵢ as the client verification, based on the cached result. If Wᵢ is valid, the proxy service 30 transfers the client verification result to the provider 20A (operation (1-3) in FIG. 10). If the client authentication result cached in the proxy service 30 is within the term of validity, this client authentication result is transferred, and the proxy service 30 does not need to make the client authentication request again. Accordingly, the connection between proxy service 30 and security token service 40 may be omitted.

Also, the proxy service 30 caches the value Wᵢ as the use history of the coupon ticket for the client 10 in making the client verification.

The provider 20A trusts the received client verification result, and provides the service to the client 10 (operation (1-4) in FIG. 10). The provider 20A also caches the route value W₀ and the value Wᵢ as the use history of the client 10. Thereby, when the provider 20A makes communication with this client 10 continuously, the provider 20A itself can make the client verification, and the connection to the proxy service 30 may be omitted.

Case 2: Consecutive Requests to the Provider 20A

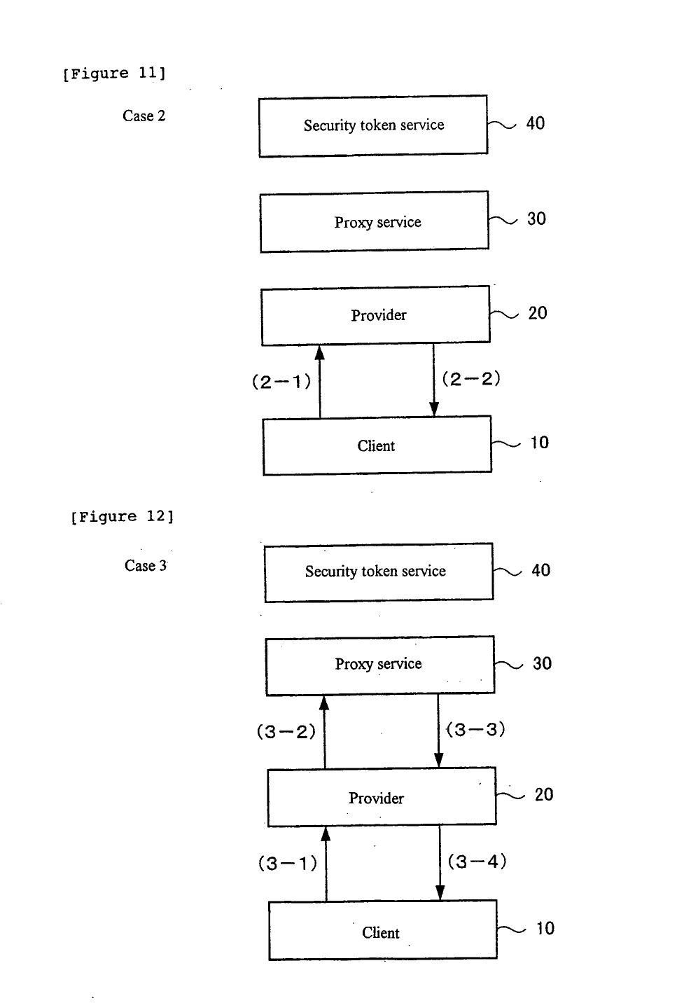

FIG. 11 illustrates the operation of the client 10, the provider 20A and the proxy service 30 in case 2.

When the client 10 makes the service requests consecutively to the provider 20A without using the services of other providers 20A, the connection between proxy service 30 and provider 20 may be omitted, as described above.

First of all, as in case 1 for the first request, the client 10 issues a service request, together with PayWord Wⱼ corresponding to the necessary number of coupons and the route value W₀ to the provider 20A (operation (2-1) in FIG. 11).

The provider 20A, which caches the use history of the client 10, can verify the validity of PayWord Wⱼ. If the provider 20A itself confirms the validity of Wⱼ, the service is provided to the client 10 (operation (2-2) in FIG. 11). In this way, if PayWord is employed, the third party (proxy service 30 or security token service 40) is not needed for verification between same provider 20A and client 10, whereby the service is provided only by communication between two parties. Also, as a rough estimate, the computation of the hash function is 10,000 time faster than the electronic signature applied by an RSA encryption method, as well known. Accordingly, it is possible to greatly reduce the load on the client 10 and the provider 20A, and the communication time.

Case 3: Re-Request to the Provider 20A after Request to the Provider 20B.

FIG. 12 illustrates the operation of the client 10, the provider 20A and the proxy service 30 in case 3.

The client 10 can also use the coupon ticket with the same PayWord to other providers 20B. When the service to the provider 20A is employed again after the service to the provider 20B is used in accordance with the procedure of case 1, employing the PayWord coupon ticket, the client 10 presents PayWord Wᵢ and the route value W₀ to the provider 20A and requests the service (operation (3-1) in FIG. 12).

Since the proxy service 30 distributes and accumulates the latest use history of the client 10 by circulating around the providers 20, the service is provided between two parties, as in case 2, when the provider 20A knows the latest use history of the client 10 in the provider 20B. However, when the provider 20A does not know the latest use history of the client 10 in the provider 20B, the contradiction arises by verification of Wk (collation result is “false”). Thus, in this case alone, the verification of Wₖ is requested to the proxy service 30 (operation (3-2) in FIG. 12).

The proxy service 30, which caches the use history of the client 10 in the provider 20B, verifies the validity of PayWord Wₖ and informs the verification result to the provider 20A (operation (3-3) in FIG. 12).

The provider 20A trusts the client verification result of the proxy service 30, and provides the service to the client 10 (operation (3-4) in FIG. 12). In this case, the proxy service 30 and the provider 20A update the use history of the client 10. In this way, the proxy service 30 caches the use history of the client 10 in each provider 20, whereby the coupon ticket is shared among a plurality of providers 20, and the client authentication with the single sign on is implemented.

As described in the above cases 1 to 3, the client 10 only needs to transmit the same route value W₀ and PayWord value in making the service request, and does not need to request the client authentication by itself. Also, when making the service request to the same provider 20, the provider 20 does not need to make the client verification request every time, but can make the client verification by itself, using PayWord. Accordingly, as case 3 is applied more frequently, the service can be provided with a smaller average connection number, whereby the single sign on to the plurality of providers 20 is enabled.

When the proxy service 30 distributes or accumulates the latest use history of the client 10 by circulating around the providers 20 under management by the method as described by referring to the flowchart of FIG. 8, the case 3 is applied more frequently, whereby the performance of the provider 20 in providing the service is enhanced.

The client 10 may try to receive the service illegally by forging the use history, but if the proxy service 30 accumulates all the use histories for the client 10 performed after the circulation at the previous time, such an illegal use is prevented. Therefore, the provider 20 holds all the latest use histories not accumulated by the proxy service 30 among the use histories for the client 10. Thus, the proxy service 30 confirms the latest use histories collectively, whereby any illegal use is detected. If illegal use is detected, the proxy service 30 modifies the latest use history of the client 10, and distributes the modified history to the plurality of providers 20.

Also, the accounting management for the client employing the service is made, using PayWord, as previously described, but the accounting management may be made based on not only PayWord but also other well-known accounting methods.

As another example of this embodiment, an authentication system using a one-time password as encoded data including the information of the service use history of client 10 will be now described.

When the client 10 logs in the provider 20, a different password (one-time password) is employed every time. In this case, the information used when the client 10 then logs in is distributed in advance to the provider 20 having log-in possibility by the proxy service 30. Thereby, while the client 10 employs the different password every time, the client authentication is enabled by the communication between two parties of the provider 20 and the client 10.

Two kinds of one-time password are considered, including
I. One-time password created from predetermined fixed password and nonce (information only effective for one time of use), and the value of password creation time, created, and
II. One-time password with hardware token that is shared between proxy service 30 and client 10.

In the following explanation, the one-time password created from the fixed password is employed as an example.

Creating the Fixed Password and Nonce

To begin with, the client 10 requests the proxy service 30 to create the nonce. In response to this request, the proxy service 30 creates plural values (e.g., n1, n2, n3, . . . , n10) corresponding to a nonce used by the client 10 and transmits them to the client 10. Also, to log in predetermined provider 20A and another provider 20B, the client 10 sets up respective fixed passwords (e.g., PWDa, PWDb).

The cases 1, 2 and 3 are considered in the same way as the above example using PayWord.

Case 1: First Request to the Provider 20A.

In making connection to the provider 20A, the client 10 transmits the ID and one-time password PWD. Herein, the password PWD is calculated as PWD=SHAI(n1+c1+PWDa) using nonce and creation time c1. In making the first request to the provider 20A, the provider 20A transfers the ID and PWD to the proxy service 30, and requests the client authentication. The proxy service 30 calculates PWD using n1 and c1 knowing the value n1 of the nonce. Accordingly, if the value of PWD transmitted from the provider 20A is the same as the value of PWD computed using n1 and c1, the client authentication result obtained from the security token service 40 and nonce n2 to be employed in creating the one-time password at the next time are transmitted to the provider 20A. If the client authentication result acquired from the proxy service 30 has no problem, the provider 20A provides the service to the client 10.

Also, the proxy service 30 distributes the value n2 of nonce which the client 10 employs to create the next password to another provider 20.

Case 2: Consecutive Requests to the Provider 20A.

The client 10 transmits the ID and PWD=SHAI(n2+c2LPWDa) to the provider 20A. The provider 20A computes the PWD using n2 which is acquired from the proxy service 30 to verify the client 10. In this way, when the request to the provider 20A is consecutively made, the provider 20A itself makes the client verification without connecting to the proxy service 30.

The proxy service 30 accumulates n2 from the provider 20A when circulating around, and distributes n3 employed at the next time by the client 10 to another provider 20.

Case 3: Re-request to the Provider 20A After Request to the Provider 20B.

Suppose that the client 10 employs nonce n3 to create PWD in making connection to the provider 20B. Thereafter, to connect to the provider 20A again, the client 10 transmits the ID and PWD=SHAI(n4+c4+PWDa) to the provider 20A.

If the proxy service 30 appropriately circulates around the providers 20 under management, the provider 20A already knows nonce n4, thereby verifying the password PWD.

When the circulation of the proxy service 30 is not in time for the service request of the client 10, the provider 20A can not verify the password PWD, and requests the proxy service 30 to verify the PWD. As a result of verification, if the PWD is correct, the provider 20A provides the service to the client 10.

As described above, the proxy service 30 distributes in advance the nonce to provider 20 to compute the one-time password employed at the next time by the client 10. Thereby, the provider 20 verifies the password PWD without making an inquiry to the proxy service 30, thereby providing the service.

When the one-time password with hardware token is employed, instead of employing the one-time password created from the fixed password and nonce and the value of password creation time, a hardware token generator is disposed between the proxy service 30 and the client 10, and the proxy service 30 distributes the password possibly employed at the next time by the client 10 to the provider 20. In this way, the provider 20 can log in with the one-time password and implement the client authentication with the single sign on, without disposing the hardware token generator for each client 10.

When the nonce for the client 10 to create the password PWD is used up to n10, measures for returning to n1 again or requesting the new creation of a nonce to the proxy service 30 may be taken to create the password PWD at the next time.

Description of Symbols

10 . . . Client
20 . . . Provider
21, 31, 41 . . . Communication control part
22 . . . Service executing part
23, 32, 42 . . . Authentication executing part
30 . . . Proxy service
33 . . . Use history distributing/accumulating part
40 . . . Security token service
101 . . . CPU (Central Processing Unit)
103 . . . Main memory
105 . . . Magnetic disk drive (HDD)
106 . . . Network interface

The present invention can be realized in hardware, software, or a combination of hardware and software. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. The concepts of this invention may be used for many applications. Thus, although the description is made for particular arrangements and methods, the intent and concept of the invention is suitable and applicable to other arrangements and applications. It will be clear to those skilled in the art that other modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art. Thus, it should be understood that the embodiments has been provided as an example and not as a limitation. The scope of the invention is defined by the appended claims.

1. An authentication system for performing a client authentication with a single sign on by collectively managing a plurality of providers for providing predetermined services via a network, comprising:
a provider for providing a predetermined service via the network;
an authentication server for performing the authentication for a client making a service request to said provider; and
a proxy server for managing an authentication request which said provider makes to said authentication server, said proxy server being interposed between said authentication server and said provider;
wherein said proxy server preserves an authentication result of said authentication server, and vicariously executes the authentication for said client based on said preserved authentication result without transferring said authentication request received from said provider to said authentication server under certain conditions.

2. The authentication system according to claim 1, wherein said provider preserves a service use history of said client, and when it is clear that a service can be provided to said client based on said service use history, the service is provided to said client without making said authentication request.

3. The authentication system according to claim 2, wherein said proxy server acquires and manages the service use history of said client from said provider, and determines whether or not the service can be provided to said client, based on the authentication result from said authentication server and said service use history, in response to an authentication request from a predetermined provider.

4. The authentication system according to claim 2, wherein said proxy server accumulates the service use history of said each client for comparison by circulating around the plurality of providers, selects the latest contents and updates the service use history of said each client in said each provider with said latest contents.

5. An authentication system comprising:
a plurality of providers for providing predetermined services via a network; and
a verification server for determining whether or not the service can be provided to a client making a service request to a predetermined provider in response to a verification request from said predetermined provider; wherein
said provider preserves a service use history of said client;
said verification server generates encoded data including the authentication information of said client and the information of the service use number by said client to provide said encoded data to said client, and acquires and manages said service use history from said provider, in which when a predetermined client makes a service request to a predetermined provider, employing said encoded data, said verification server determines whether or not the service can be provided by collating said encoded data and the service use history of said client in response to a verification request from said provider.

6. The authentication system according to claim 5, wherein when a predetermined client makes a service request employing said encoded data, said provider provides a service to said client without making a verification request to said verification server, if it is clear that the service can be provided to said client by collating said encoded data and said service use history.

7. The authentication system according to claim 5, wherein said verification server accumulates the service use history of said each client for comparison by circulating around the plurality of providers, selects the latest contents and updates the service use history of said each client in said each provider with said latest contents.

8. A server for implementing a single sign on by collectively managing a plurality of providers for providing predetermined services via a network, comprising:
use history storage for storing a service use history of a predetermined client in said providers;
authentication result storage for storing an authentication result for said predetermined client that is acquired by requesting a predetermined authentication server; and
verification apparatus for determining whether or not the service can be provided to said predetermined client employing said service use history stored in said use history storage and said authentication result stored in said authentication result storage, in response to an inquiry from said providers;
wherein said verification apparatus requests said authentication server to make a client authentication for determining whether or not the service can be provided, when the authentication result preserved in said authentication result storage is invalid.

9. The server according to claim 8, further comprising a use history accumulator for accumulating the service use history of said each client by circulating around the plurality of providers, and selecting and storing the latest contents in said use history storage.

10. The server according to claim 9, wherein said use history accumulator accumulates the service use history by preferentially circulating around the providers having a greater total amount of communication with the clients.

11. The server according to claim 8, further comprising an encoded data generator for generating encoded data including the authentication information of said client and the service use number by said client, in which when a predetermined client makes a service request to a predetermined provider, employing said encoded data, said verification apparatus determines whether or not the service can be provided by collating said encoded data and the service use history of said client stored in said use history storage.

12. An authentication method for making the authentication for a client making a service request to a provider, employing a computer, comprising:
collating encoded data in which a service use history of said client is encoded and the information of the service use history of said client stored in predetermined storing means;
determining whether or not the service can be provided to said client, based on the authentication information for said client stored in said predetermined storing means, when a collation result at said first step is “false”; and
requesting a predetermined authentication server to authenticate said client and determining whether or not the service can be provided to said client based said acquired authentication result, when said authentication information for use at said second step is invalid.

13. The authentication method according to claim 12, further comprising determining that the service can be provided to said client when the collation result of said collating is “true”.

14. The authentication method according to claim 12, further comprising storing said authentication result acquired at said requesting as said authentication information for use at said determining, in predetermined storing means.

15. A program including computer code for enabling a computer to perform the functions of:
use history storing for storing a service use history of a predetermined client in a provider;
authentication result storing for storing an authentication result for said predetermined client that is acquired by requesting a predetermined authentication server; and
verification for requesting said authentication server to make a client authentication for determining whether or not the service can be provided to said predetermined client employing said service use history stored in said use history storing and said authentication result stored in said authentication result storing, in response to an inquiry from said provider, and determining whether or not the service can be provided, when the authentication result preserved in said authentication result storing is invalid.

16. The program according to claim 15, further comprising computer code for enabling the computer to perform the function of use history accumulating for accumulating the service use history of each client by circulating around the plurality of providers, and selecting and storing the latest contents of said use history storing.

17. The program according to claim 16, further comprising computer code for enabling the computer to perform the function of use history accumulating for accumulating the service use history by preferentially circulating around the providers having a greater total amount of communication with the clients.

18. The program according to claim 16, further comprising computer code for enabling the computer to perform the function of use history distributing for distributing said latest contents of said service use history stored in said use history storing to said providers.

19. The program according to claim 18, further comprising computer code for enabling the computer to perform the function of use history storing for distributing said latest contents of said service use history to said providers by preferentially circulating around the providers making no connection for inquiring whether or not the service can be provided for more than a predetermined time.

20. The program according to claim 18, further comprising computer code for enabling the computer to perform the function of use history storing for distributing said latest service use history to said providers by preferentially circulating around the providers having a greater number of communications with the clients for which said latest contents of said service use history is accumulated by said use history accumulating means.

21. The program according to claim 15, further comprising computer code for enabling the computer to perform the function of encoded data generating for generating encoded data including the authentication information of said client and the information of the service use number by said client, and a function as said verification for determining whether or not the service can be provided by collating said encoded data and the service use history of a client stored in said use history storing, when a predetermined client makes a service request to a predetermined provider, employing said encoded data.

22. A computer readable recording medium having recorded thereon the program according to claim 15.

23. A computer readable recording medium having recorded thereon the program according to claim 16.

24. A computer readable recording medium having recorded thereon the program according to claim 17.

25. A computer readable recording medium having recorded thereon the program according to claim 18.

26. A computer readable recording medium having recorded thereon the program according to claim 19.

27. A computer readable recording medium having recorded thereon the program according to claim 20.

28. A computer readable recording medium having recorded thereon the program according to claim 21.
